(19) United States
(12) Patent Application Publication
(10) Pub. No.: US 2024/0351471 A1
(43) Pub. Date: Oct. 24, 2024

(54) HIGH VOLTAGE BATTERY STATE OF HEALTH

(71) Applicant: INNOVA ELECTRONICS CORPORATION, Irvine, CA (US)

(72) Inventors: Keith ANDREASEN, Garden Grove, CA (US); Thuan Cong HUYNH, Ho Chi Minh City (VN); Dieu Huu TRAN, Ho Chi Minh City (VN); Thanh Minh VO, Ho Chi Minh City (VN); Phuong PHAM, Fountain Valley, CA (US)

(21) Appl. No.: 18/137,753

(22) Filed: Apr. 21, 2023

(51) Int. Cl. B60L 58/16; B60L 58/12; B60L 58/22; G07C 5/08

(52) U.S. Cl. CPC B60L 58/16; B60L 58/12; B60L 58/22; G07C 5/0825; B60L 58/24; B60L 2240/14; B60L 2240/547; B60L 2250/16; G07C 2205/02

(57) ABSTRACT

A method of determining a state of health of a vehicle battery on a hybrid or electric vehicle includes receiving diagnostic data including a trouble code status, an internal resistance and temperature of the battery cells. The vehicle battery charging and discharging are monitored and cell voltage for each of the battery cells is requested when the battery charging meets a charging threshold and the battery discharging meets a discharging threshold. The cell voltage is received from each of the battery cells and a determination of a voltage balance is made by comparing received voltages to a known average voltage range. A battery state of health is calculated based on a combined assessment of the diagnostic trouble code status, the internal resistance and temperature of the battery cells, and the voltage balance.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to monitoring and analysis of vehicle operations, and more specifically, to a device, system, and related methodology associated with determining a state of health for a vehicle battery, such as a vehicle battery on a hybrid vehicle.

### 2. Description of the Related Art

Historically, many vehicles were gasoline-powered vehicles utilizing an internal combustion engine. The relatively compact size of the internal combustion engine, reliability, and available fuel source lead to widespread adoption of gasoline-powered vehicles. However, despite the many advantages associated with gasoline-powered engines, several drawbacks, particularly environmental drawbacks, became apparent in recent years, especially in view of the large numbers of gasoline powered vehicles. More specifically, operation of a conventional gasoline-powered engine produces a number of byproducts that are considered to have a negative impact on the environment. For instance, some estimates suggest that on a yearly basis 1.7 billion tons of CO2 is released in the atmosphere from tailpipes of gasoline-powered vehicles in the United States. In addition to the environmental drawbacks, gasoline-powered vehicles are subject to volatile changes in the price of gasoline, thereby creating uncertainties surrounding the cost of operating the vehicle.

In view of the drawbacks associated with conventional gasoline-powered vehicles, advancements have been made to provide alternative power sources or drive mechanisms within a vehicle. For instance, hybrid vehicles or electric vehicles have been developed which utilize an electric propulsion system, either in whole (e.g., an electric vehicle) or in part (e.g., a hybrid vehicle). In most cases, the vehicle's source of electric power necessitates the use of an electrical reserve, which is the high voltage battery.

Due to the growing reliance on electrical power in vehicles, there is a need in the art for an ability to determine an overall health of the batteries within a vehicle. Various aspects of the present disclosure address this particular need, as will be discussed in more detail below.

### BRIEF SUMMARY

In accordance with one embodiment of the present disclosure, there is provided a method of determining a state of health of a vehicle battery on a hybrid vehicle or an electric vehicle, with the vehicle battery being comprised of a plurality of battery cells. The method includes receiving diagnostic data from a vehicle, with the diagnostic data including a diagnostic trouble code status, an internal resistance of the cells in the vehicle battery, and a temperature of the cells in the vehicle battery. The method additionally includes monitoring vehicle battery charging and vehicle battery discharging and requesting cell voltage for each of the plurality of battery cells when the vehicle battery charging meets a charging threshold and the vehicle battery discharging meets a discharging threshold. The cell voltage is received from each of the plurality of battery cells and determination of a voltage balance is made by comparing received voltages to a known average voltage range. A battery state of health is calculated based on a combined assessment of the diagnostic trouble code status, the internal resistance of the cells in the vehicle battery, the temperature of the cells in the vehicle battery, and the voltage balance.

The diagnostic data may additionally include a number of cells in a vehicle battery on the vehicle. The calculation of the battery state of health may additionally include an assessment of the number of cells in the vehicle battery on the vehicle

The method may further include displaying the calculated battery state of health on a display. The displayed battery state of health may be in the form of a digital gauge and/or in the form of a digital table.

The charging threshold may be associated with a specified vehicle deceleration, and the discharging threshold may be associated with a specified vehicle acceleration.

The method may also include identifying driving instructions associated with a specified vehicle deceleration associated with the charging threshold and a specified vehicle acceleration associated with the discharging threshold. The identified driving instructions may be displayed on a handheld electronic device.

The method may additionally comprise identifying a drive cycle associated with the step of determining the voltage balance. The drive cycle may be vehicle specific, and the method also include identifying the drive cycle based on vehicle identification information associated with the vehicle.

According to another embodiment, there is provided a device for determining a state of health of a vehicle battery on a hybrid vehicle. The device includes a data connector operatively engageable with a diagnostic port on the vehicle, and a processor in communication with the data connector. The processor is configured to implement the steps comprising receiving diagnostic data from a vehicle via the data connector, with the diagnostic data including a diagnostic trouble code status, an internal resistance of the cells in the vehicle battery, and a temperature of the cells in the vehicle battery. The processor also implements monitors vehicle battery charging and vehicle battery discharging in accordance with a prescribed schedule and requests cell voltage when the vehicle battery charging meets a charging threshold and the vehicle battery discharging meets a discharging threshold. The processor additionally implements receiving cell voltage and determining a voltage balance by comparing received voltages to a known average voltage range. The processor further implements the calculation of a battery state of health based on a combined assessment of the diagnostic trouble code status, the internal resistance of the cells in the vehicle battery, the temperature of the cells in the vehicle battery, and the voltage balance.

The device may additionally include a display screen in communication with the processor, with the display screen being configured to display information related to the battery state of health.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic diagram of an exemplary display of a battery state of health;

FIG. 2 is a schematic diagram of a system for determining the battery state of health;

FIG. 3 is a chart depicting an exemplary weight assignment of factors contributing to the battery state of health;

FIG. 4 is a flow chart illustrating an exemplary method of determining a battery state of health and displaying a calculated battery state of health;

FIG. 5 is an exemplary screenshot associated with linking/facilitating communication between a data acquisition and transfer device (DAT) and a vehicle computer;

FIG. 6 is an exemplary screenshot associated with a decoded VIN and asking a user to confirm the decoded VIN properly identifies their vehicle;

FIG. 7 is an exemplary screenshot associated with linking to a BMS on a vehicle and retrieving select vehicle data/information; and

FIG. 8 is an exemplary chart depicting thresholds for various factors contributing to the battery state of health;

Common reference numerals are used throughout the drawings and the detailed description to indicate the same elements.

### DETAILED DESCRIPTION

The detailed description set forth below in connection with the appended drawings is intended as a description of certain embodiments of a hybrid vehicle battery state of health method and related devices and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

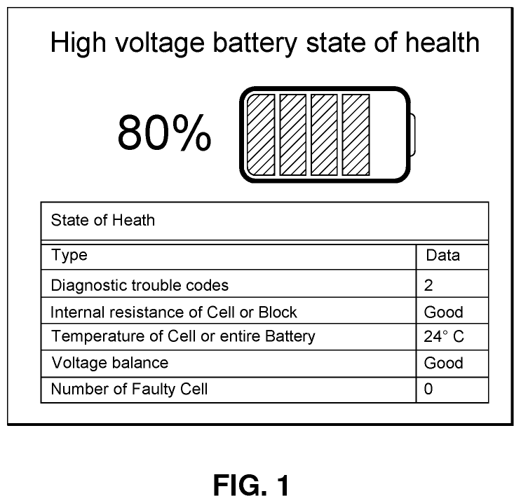

Various aspects of the present disclosure relate to evaluating a battery health status for a vehicle battery or battery system on a hybrid or electric vehicle. The evaluation considers several battery-specific parameters, including parameters related to battery construction, real-time battery conditions, as well as battery performance to determine a battery health score. Once a battery health score is determined, the health score may be displayed on a user-friendly display to convey the health score in an easily understood format. FIG. 1 is an example of a display of a battery state of health including an icon, a numerical value, as wells as a chart providing a summary of certain aspects that factor into the battery state of health. The icon may provide an easy-to-understand visual depiction of a battery state of health and the numerical value may provide a quantitative estimation of the battery state of health.

Various aspects of the methodology associated with the battery state of health, and the hardware associated therewith, may be configured to determine the battery state of health with minimal or no input by a user. Furthermore, the content displayed, audibly conveyed, or otherwise communicated to the user may be communicated in an easy-to-understand manner. Therefore, automotive expertise may not be required to determine the battery state of health.

Additional aspects of the present disclosure may relate to identifying a most likely problem in the battery or a related vehicle component or system. Repair parts and/or repair procedures for fixing the most likely problem may be identified and provided to a user. The system may also be capable of calculating a hypothetical improved score associated with the most likely problem being corrected. Thus, the user may be provided with a quantified improvement in the battery health score for one or more repairs made to the vehicle, which may help the user to decide whether the cost of the repair is worth the likely improvement.

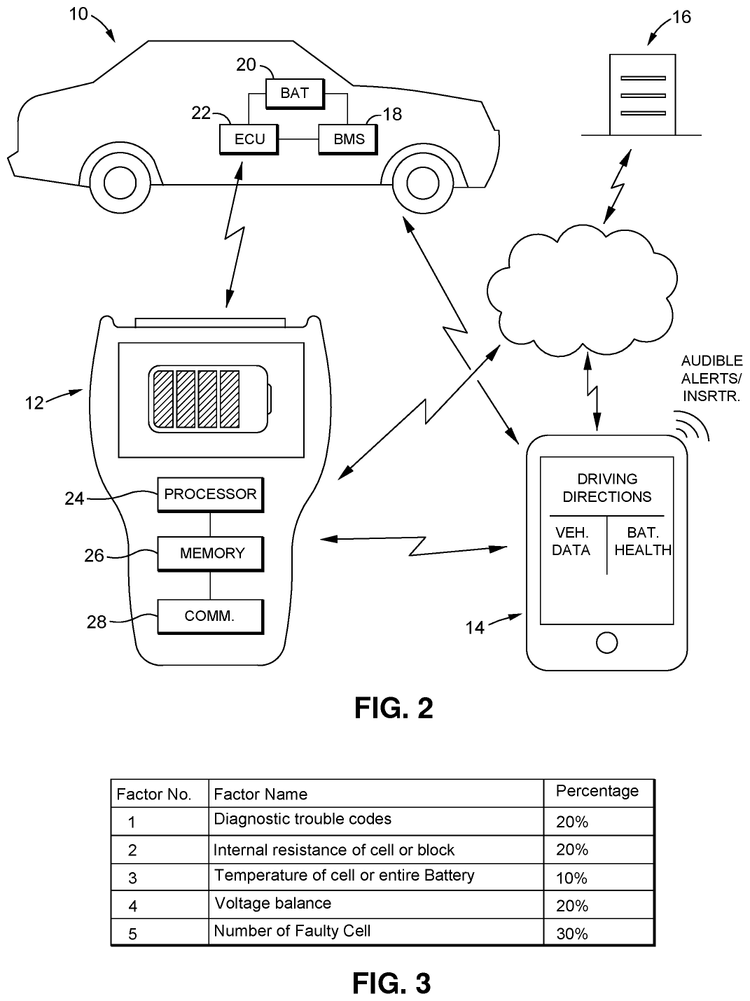

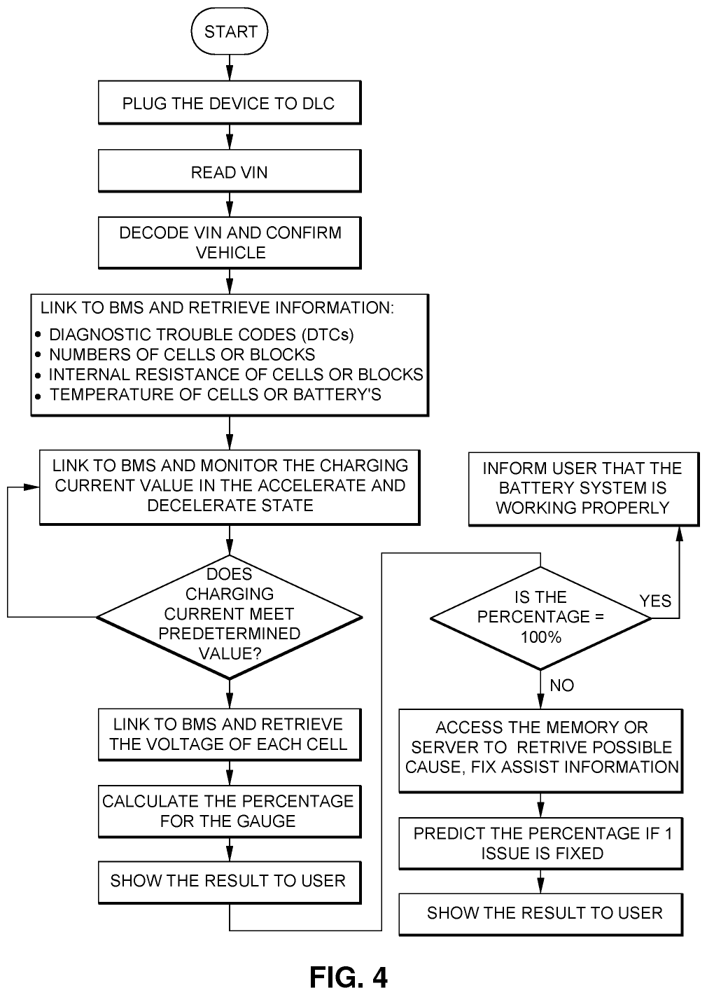

FIG. 2 is an exemplary schematic system-level overview for determining a vehicle battery state of health. In more detail, there is depicted a vehicle 10, a data acquisition and transfer (DAT) device 12, a handheld communication device 14, and a remote server 16. As noted above, determination of the battery state of health may be particularly desirable for hybrid vehicles and/or electric vehicles. The term hybrid vehicle may broadly refer to a vehicle that includes a conventional internal combustion engine along with an electric propulsion system. Hybrid vehicles may be associated with a higher fuel economy than conventional internal combustion engines due to their ability to propel the vehicle, at times, solely with the electrical powertrain, without using the internal combustion engine. The reliance on electrical power as the sole source of propulsion during certain modes of operation may require more robust battery systems than the batteries used in conventional internal combustion engines. It is also contemplated that various aspects of the present disclosure maybe be applicable to motorcycles or electronic bicycles, golf carts, scooters, etc. As such, the term vehicle may broadly refer to any mode of transportation that is at least propelled at least in part via electric power supplied by a battery. As used herein, the term battery may refer to a single battery, multiple batteries, a battery pack, or an entire battery system. It is understood that in most vehicles, the vehicle battery is comprised of a plurality of battery cells that collectively supply power needed during operation of the vehicle 10.

The vehicle 10 may also include a battery energy management system (BMS) 18 for controlling and monitoring the operation of the battery 20 to maintain the battery 20 at a similar state of charge and operate at high performance. In this regard, the BMS 18 may monitor battery current, battery voltage, battery temperature, battery capacity, etc. As such, the BMS 18 may include a processor and computer executable instructions stored thereon for controlling and monitoring the battery 20 in accordance with such instructions. The processor may be in communication with the battery 20, as well as various sensors needed to implement the functionality associated with the BMS 18. The BMS 18 may be accessible via a diagnostic port 22 on the vehicle 10, such as an on-board diagnostic (OBD-II) port.

The DAT 12 may be used to access the battery data via the diagnostic port 22. The DAT 12 may include, but is not limited to a dongle, scan tool, code reader, or other data retrieval device or modality known in the art. It is contemplated that the DAT 12 may be operatively connected to the diagnostic port 22 via wired communication (e.g., the DAT 12 being plugged into the diagnostic port 22), or via wireless communication. The DAT 12 may include computer executable instructions (e.g., software) stored thereon or downloadable thereon for executing the functionalities described herein. In this regard, the DAT 12 may include a processor 24 for implementing the instructions, and a memory circuit 26 for storing the instructions, reference data, thresholds, as well as any data that may be retrieved from the vehicle. A communication circuit 28 may also be included on the DAT 12 to facilitate communications with an external device, such as the handheld communication device 14 (e.g., a smartphone, smart watch, tablet computer, etc.) or the remote server 16.

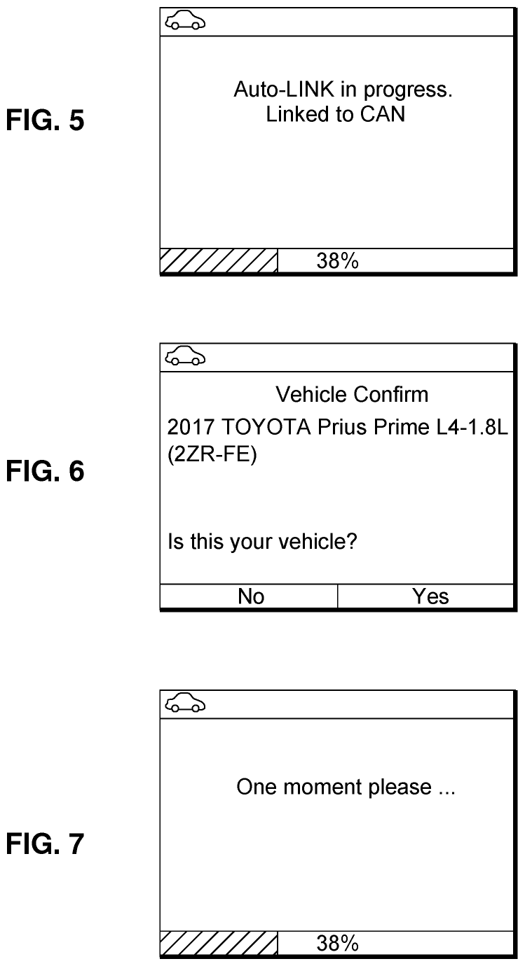

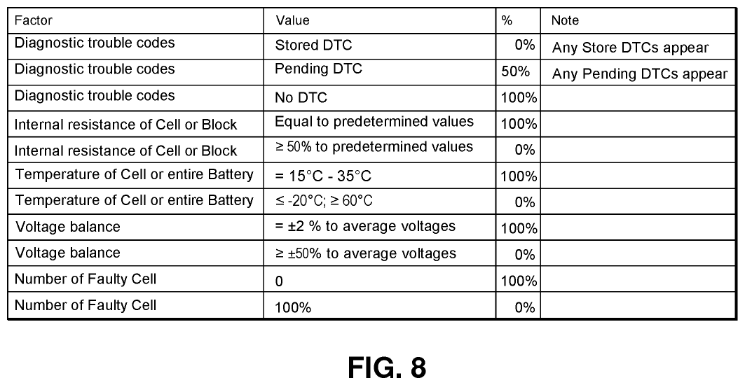

Once connected to the diagnostic port 22, the DAT 12 may be capable of requesting vehicle identification information, e.g., an electronic vehicle identification number (VIN), and using that information to facilitate any vehicle-specific configuration of the DAT 12, such as identifying vehicle-specific communication protocols or data thresholds used in the algorithm. In this regard, the DAT 12 may be configured to initiate communication with the vehicle computers/ECUs in response to connection with the diagnostic port 22 having been established. A vehicle data request signal for the data needed for determining the battery health score may be generated and transmitted independent of any user input or independent of a user navigating a user interface on the DAT 12. FIG. 5 is an exemplary screenshot that may be depicted on a display screen integrated on the DAT 12 or on a device in communication with the DAT 12, such as a smartphone, which communicates to the user that the DAT 12 is connected to the controller area network (CAN) of the vehicle. The connection may be implemented in response to a physical connection between the DAT 12 and the diagnostic port on the vehicle, or a wireless connection therebetween. As noted above, this step may proceed independent of user input. However, it is contemplated that in certain implementations, user input or display screen navigation may be required without departing from the spirit and scope of the present disclosure. Once the vehicle identification information is retrieved, the display screen may depict the year, make, model, engine, etc., of the vehicle and ask the user to confirm that such information is accurate, such as is depicted in FIG. 6.

According to one embodiment, the battery health score is determined based on a combined assessment of diagnostic trouble codes (DTCs), the numbers of healthy and faulty cells or blocks in the battery 20, an internal resistance of the cells or blocks in the battery 20, and the temperature of the cells or blocks in the battery 20, which may be retrieved using the DAT 12. An algorithm or other predetermined rules may be used to evaluate the foregoing factors to determine the battery health score. FIG. 3 is an exemplary chart depicting the weight assigned to each factor according to one particular algorithm. However, it is understood that the weights may vary without departing from the spirit and scope of the present disclosure.

In one embodiment, each variable is an all-or-nothing variable, in which case all of the percentage points for a given variable are either added to the overall battery health score, or withheld from the overall battery health score. For instance, in the chart shown in FIG. 3, DTCs contribute to 20% of the vehicle health score. Thus, if a sufficient absence of DTCs are present in data retrieved from the vehicle, the full 20% of the DTC portion of the overall battery health score would be used in calculating the battery health score. Conversely, if there is a unacceptable presence of DTCs in the data retrieved from the vehicle, the full 20% of the DTC portion of the overall battery health score would be withheld when calculating the battery health score. Other factors may have a defined acceptable range, such that if the data shows the variable as falling within the acceptable range, then all of the allotted percentage points would be used when calculating the battery health score. On the other hand, if the data shows the variable as falling outside of the acceptable range, then all of the allotted percentage points would be withheld from the battery health score.

In another embodiment, each variable may be capable of having a fraction of the total possible percentage points being used when calculating the battery health score. For instance, in the case of the DTCs, if no DTCs are present in the retrieved data, then the entirety of the DTC portion of the overall battery health score would be used when calculating the battery health score. However, if a first level of DTCs are present (e.g., 1-3), then only a fraction of the DTC portion of the overall battery health score would be used when calculating the battery health score. The magnitude of the fraction used in calculating the battery health score may decrease as more DTCs are present in the data, until an unacceptable threshold of DTCs are found in the data, in which case, the entirety of the DTC portion of the overall battery health score is withheld when calculating the battery health score. The same analysis may apply when evaluating factors having a predefined acceptable range. A first range may be defined, in which all of that factor's portion of the overall battery health score would be used when calculating the battery health score, and a second range may be defined, in which only a fraction of that factor's portion of the overall battery health score would be used when calculating the battery health score.

Once the DAT 12 is operatively connected to the vehicle 10, the DTCs may be retrieved for use in determining the battery health score. According to one embodiment, the battery health analysis may consider all DTCs related to, generated by, or otherwise associated with the BMS 18. The DTCs may be vehicle-specific, and in some instances, battery-specific. The nature of the DTCs may be such that they relate to issues associated with battery voltage, battery current, battery capacity, battery temperature, or other parameters related to battery function or optimization. In one particular implementation, the evaluation of the DTCs may relate to the presence or absence of battery-related DTCs, whether those DTCs are stored DTCs (e.g., historical DTCs) or pending DTCs (active DTCs). According to one embodiment, the DTCs may be continuously monitored at all times or on a regular basis. An absence of any DTCs related to the BMS 18 may be an indication of a generally healthy battery 20. However, the presence of BMS-related DTCs may be an indication of an unhealthy battery or otherwise cause for concerning, depending on the nature of the DTCs. The analysis of the DTCs may be vehicle-specific and/or battery specific, and thus, a library or database of DTCs indicative of an unhealthy battery 20 matched with vehicle identifying information or battery identifying information may be stored on a memory circuit 26 located on the DAT 12 or on a remote server 16 accessible by the DAT 12.

Evaluation of the battery health score may also include an internal resistance check. Along these lines, almost all batteries 20 used in a vehicle 10 may be associated with an internal resistance value. In most cases, the internal resistance value may increase gradually over time. When the internal resistance value is too high, it may reduce the performance of battery 20 and the ability of the battery 20 to charge or discharge. Therefore, the internal resistance value may be provided or read from the BMS 18 using an OBD command send from the DAT 12. According to one embodiment, the internal resistance values may be provided for each cell of the battery 20. The received internal resistance value may be compared with a known value associated with a healthy battery 20 to determine if the battery 20 under test is degraded or bad. For instance, for a 2017 Toyota Prius L4, 1.8L (2ZR-FXE) Hybrid, a preferred upper threshold for an internal resistance of each cell may be 0.006 Ω. a An actual measured value being greater than 0.006 Ω may be an indication of a faulty cell. The analysis of the internal resistance may be vehicle-specific and/or battery specific, and thus, a library or database of internal resistance thresholds matched with vehicle identifying information or battery identifying information may be stored on a memory circuit 26 located on the DAT 12 or on a remote server 16 accessible by the DAT 12.

A temperature check may also be performed when evaluating battery health. A high battery temperature may accelerate the chemical processes in the battery during charging and discharging. The risk of corrosion, self-discharge, and sulfation increases at a high temperature, which may reduce the service life of the battery 20. In most cases, a battery's “comfort zone” may between 15° C. and 35° C. However, it is understood that the scope of the present disclosure is not limited thereto, and that temperatures below 15° C. and above 35° C. may also be associated with a particular battery's comfort zone without departing from the spirit and scope of the present disclosure. If the temperature of the battery 20 is higher than the “comfort zone” temperature, it shows that there is a degraded or inefficiency of battery cooling system, and it causes decrease the battery's life.

The temperature may be obtained by a request sent from the DAT 12, wherein one or more temperature sensors on the vehicle 10 may obtain the requested temperature reading(s) of the battery 20 and return the measured temperature to the DAT 12. As an alternative, the temperature may be measured by separate device, and entered into the DAT 12 or other processing device (e.g., the smartphone 14) for upload to the server 16 or other location that may determine the vehicle battery health. The analysis of the temperature may be vehicle-specific and/or battery specific, and thus, a library or database of acceptable temperatures matched with vehicle identifying information or battery identifying information may be stored on a memory circuit 26 located on the DAT 12 or on a remote server 16 accessible by the DAT.

A voltage balance check may also be performed when evaluating battery health. In many cases, the vehicle battery system may include several battery blocks/cells, and thus, optimal performance may require that the voltage values of the blocks/cells be balanced by a certain degree. The DAT 12 may be used to receive battery block/cell voltage data, as well as discharging current values and charging current values, which may be used in calculating a voltage balance. The analysis of the voltage balance may be vehicle-specific and/or battery specific, and thus, a library or database of voltage balance data indicative of an unhealthy battery matched with vehicle identifying information or battery identifying information may be stored on a memory circuit 26 located on the DAT 12 or on a remote server 16 accessible by the DAT 12.

The voltage balance check may require operation of the vehicle 10 to obtain discharging current values and charging current values, and thus, the voltage balance check may be associated with a particular drive cycle to obtain the require data. For instance, the vehicle may be required to drive a certain distance, undergo a certain number of accelerations, experience an acceleration that is of a particular magnitude, undergo a certain number of decelerations, and/or experience a deceleration that is of a particular magnitude, etc. In particular, when a vehicle 10 is accelerated, the motor may consume electric energy from the battery 20, and thus, the battery discharging current value may be associated with a positive value. When the vehicle 10 is accelerated at a high rate until the battery current value reaches a calculated upper threshold, an algorithm may compare the voltage value of each block or each cell with the average voltage value. If the difference is greater than a predetermined value, the battery may be degraded or bad.

When the vehicle 10 is decelerated, the motor may work like a generator to charge the battery 20, and thus, the battery charging current value may be associated with a negative value. When the vehicle 10 is decelerated at a high rate, the battery's current may drop below a prescribed bottom threshold. The algorithm may compare the voltage value of each block with the average block voltage value. If the difference is greater than a predetermined value, it may be an indication of a degraded or bad battery 20.

It is contemplated that the DAT 12 may be configured to monitor the vehicle during normal operation of the vehicle without requiring any input from the user to initiate the monitoring, other than facilitating the initial connection of the DAT 12 to the diagnostic port. In this regard, the DAT 12 may be configured for autonomous operation. The DAT 12 may monitor the operation of vehicle at all times, and when the vehicle 10 meets the condition the DAT 12 will start calculating and checking the status of cell voltage or block voltage.

On the other hand, DAT 12 may be configured to allow the user to perform a test intentionally by driving the vehicle to meet the certain operational parameters needed to calculate the battery health score. In this regard, instructions may be displayed or spoken to a driver to alert the driver of the conditions needed for the test (e.g., acceleration at a certain rate, deceleration at a certain rate, etc.). The instructions may be depicted on a display located on the DAT 12, spoken via a speaker located on the DAT 12, or alternatively, may be conveyed using resources external to the DAT 12, such as displayed or spoken on the smartphone 14, or via the vehicle's infotainment center, which may be paired with the DAT or the smartphone 14. For instance, the smartphone 14 may receive the instructions from the remote server 16 as a result of an operative connection between the smartphone 14, the DAT 12 and the remote server 16, which may be set up during initial registration of the DAT 12. A smartphone application may also run or be implemented on the smartphone 14 to facilitate the functionalities on the smartphone 14, including communicating with the DAT 12 and/or the server 16. When the vehicle 10 meets the condition, the DAT 12 will start calculating and checking the status of cell voltage or block voltage.

The drive cycle(s) associated with the determination of the battery state of health may be vehicle-specific and/or battery-specific. Therefore, a library or database of drive cycle(s) matched with vehicle identifying information or battery identifying information may be stored on a memory circuit 26 located on the DAT 12 or on a remote server 16 accessible by the DAT 12.

The determination of the battery state of health may additionally include checking the number of battery cells in the vehicle battery 20. In this regard, conventional vehicle batteries are comprised of multiple battery cells, and if one cell has a problem, the BMS 18 may cut off the connection of this cell to prevent the failure from spreading. Thus, even a few single small batteries problems with the battery 20 may not affect the driving of the vehicle 10. However, as the number of faulty cells increases, the overall battery health may decrease.

The determination of the battery state of health may also include an evaluation of a high voltage battery state of health, which is determined by assessing and analyzing the condition of each battery cell. In particular, the health of each cell may be determined by measuring the internal resistance of each cell, the temperature of each cell, and the cell voltage, and comparing the measured values with prescribed thresholds. When one or more of the measured parameters does not comply with the prescribed thresholds, the cell may be referred to as a faulty cell, and conversely if enough of the measured parameters comply with the prescribed thresholds, then the cell may be referred to as a healthy cell. The overall battery state of health may depend on how many faulty cells are in the battery 20 and how many healthy cells are in the battery 20.

Once all of the data is gathered, the battery state of health (e.g., battery health score) may be calculated using an algorithm. FIG. 5 is an exemplary chart showing several factors which impact the battery state of health, the associated acceptable ranges (or unacceptable ranges), as well as the respective percentages or weights for each factor.

After calculating the battery state of health, the result may be displayed for user on any number of display devices, such as a display on the DAT 12, a display on the smartphone 14, or a display on the infotainment center of the vehicle 20. Furthermore, the content of the display may be include an icon, a numerical value (e.g., a percentage), as well as a summary chart depicting the factors that impacted the score.

It is contemplated that additional aspects of the present disclosure may relate to identifying a possible cause and a most likely fix for one or more battery health factors that may not meet or conform with desired standards. Thus, if the battery health score is under 100%, the system may be capable of identifying one or more fixes or areas that can be tended to so as to improve the battery health score.

If a DTC is present in the data retrieved from the vehicle, which would lower the battery health score, the system may identify a likely fix associated with the DTC which could fix an underlying diagnostic issue and/or clear the DTC if implemented. The identification of a likely fix can be achieved through known processes. For more information regarding identifying a most likely fix based on an analysis of DTC(s), please refer to the following U.S patents, owned by Innova Electronic Corporation, which is also the owner of the present disclosure: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FLED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, and U.S. Patent Application Pub. No. 2019/0304213, entitled SYSTEM AND METHOD FOR PROACTIVE VEHICLE DIAGNOSIS AND OPERATIONAL ALERT, the entire contents of each of which is expressly incorporated herein by reference.

If the measured internal resistance of the cell or block is out of range, the possible cause of the out-of-range data could relate to the BMS or the battery itself. Thus, the system may provide additional instructions for scanning for additional data (e.g., second level data) to provide further diagnostics aimed at the BMS or the battery.

If the measured temperature of a cell or the entire battery is out of range (e.g., 15° C.-35° C.), the possible causes may relate to a battery cooling fan, a battery blower assembly, a battery temperature sensor, the BMS or the Battery itself.

If the measured voltage balance is out of range (e.g., more than ±2% of average voltages), the possible cause may relate to the BMS, a service plug grip or the Battery itself.

If the number of cells or blocks is outside of an acceptable range, the possible causes may relate to the BMS or battery itself.

Information related to the possible score-improving repair (e.g., a translation of the DTC) or the underlying fix (e.g., the repair part, part number, part price, repair instructions, repair shops capable of performing the fix) may be displayed on a display accessible by the user, such as a scan tool display, smartphone display, or sent via email or SMS message to the user.

In one embodiment, the system may be capable of identifying one or more possible improvements that may be performed to improve the score. For instance, perhaps clearing certain DTCs may improve the score, or decreasing the temperature of the cells, etc. The identification of the possible improvements may be based on ease of implementation, degree of impact on score, or other factors. Any suggestion may be displayed or audibly communicated to the user via any connected display or speaker. An example of where the battery health score may be improved is where there is an issue with a battery cooling fan and 1 faulty block, which may cause the battery health score to be a first magnitude (e.g., 80%). The system may suggest fixing the battery cooling fan, which if fixed, would increase the battery health score to a second magnitude (e.g., 95%).

The battery health score analysis may also provide predictive battery health. In this regard, the system may include a historical database of vehicle health data for similarly situated vehicles (e.g., same year, make and model) which includes a timeline of typical battery health life for such batteries. Thus, the system may be able to identify where the battery under test falls on the timeline based on the retrieved data to predict how much life may remain in the battery. Furthermore, the system may also be capable of adjusting the predicted life of the battery based on suggested repairs or fixes being implemented. For instance, the system may indicate that based on the current data, the battery may have a lifespan of 12-16 months. However, if a suggested fix is implemented, the expected lifespan may increase to 18-22 months. Thus, the system may allow a user to extend the life of the battery, which may delay costs associated with battery replacement.

The battery health score may also find use in the context of a vehicle-to-vehicle or vehicle-to-infrastructure, collectively referred to as a V2X communication system to enhance safety of all drivers. In this regard, the system may be able to monitor a vehicle's battery health in real time, or at prescribed intervals, to determine battery health while the vehicle is on the road. If the battery health falls below a predetermined score or threshold, an alert may be generated to notify adjacent vehicles of the potential vulnerabilities associated with the vehicle having the low-scoring battery. The adjacent vehicles may assign a wider clearance from the vehicle having the low-scoring battery to mitigate possible accidents with that vehicle.

The battery health monitoring system may also find use as a supplemental diagnostic resource. In this regard, conventional diagnostics, e.g., those based on diagnostic data, live data, PID data, etc., may identify several options as probable causes of a diagnostic issue. For instance, there may be a DTC that may be indicative of a problem with the battery, the inverter, or the motor. The battery health score may be used to try and either pinpoint the issue to the battery, or eliminate the battery as a possible source of the issue. In this regard, if the battery health score is above a certain magnitude, the battery may be considered healthy and attention may be directed toward the inverter or the motor as the possible cause of the issue. Conversely, if the battery health score is below a certain magnitude, focus may be directed on the battery as the likely source of the issue.

Although the foregoing mentions the battery state of health as being particularly useful for hybrid vehicles, it is contemplated that certain implementations of the battery state of health may be useful for measuring battery state of health on an electric vehicle, as well as the state of health of any high voltage battery state of health of a high voltage battery on an internal combustion engine vehicle.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of determining a state of health of a vehicle battery on a hybrid vehicle, the vehicle battery being comprised of a plurality of battery cells, the method comprising the steps of:
receiving diagnostic data from a vehicle, the diagnostic data including a diagnostic trouble code status, an internal resistance of the cells in the vehicle battery, and a temperature of the cells in the vehicle battery;
monitoring vehicle battery charging and vehicle battery discharging;
requesting cell voltage for each of the plurality of battery cells when the vehicle battery charging meets a charging threshold and the vehicle battery discharging meets a discharging threshold;
receiving cell voltage from each of the plurality of battery cells and determining a voltage balance by comparing received voltages to a known average voltage range;
calculating a battery state of health based on a combined assessment of the diagnostic trouble code status, the internal resistance of the cells in the vehicle battery, the temperature of the cells in the vehicle battery, and the voltage balance; and
identifying at least one fix to improve the battery state of health.

2. The method recited in claim 1, wherein the diagnostic data additionally includes a number of cells in a vehicle battery on the vehicle.

3. The method recited in claim 2, wherein calculating the battery state of health additionally includes an assessment of the number of cells in the vehicle battery on the vehicle

4. The method recited in claim 1, further comprising the step of displaying the calculated battery state of health on a display.

5. The method recited in claim 4, wherein the step of displaying includes displaying the calculated battery state of health on a digital gauge.

6. The method recited in claim 4, wherein the step of displaying includes displaying the calculated battery state of health on a digital table.

7. The method recited in claim 1, wherein the charging threshold is associated with a specified vehicle deceleration.

8. The method recited in claim 1, wherein the discharging threshold is associated with a specified vehicle acceleration.

9. The method recited in claim 1, further comprising the step of identifying driving instructions associated with a specified vehicle deceleration associated with the charging threshold and a specified vehicle acceleration associated with the discharging threshold.

10. The method recited in claim 9, further comprising the step of displaying the identified driving instructions on a handheld electronic device.

11. The method recited in claim 1, further comprising the step of identifying a drive cycle associated with the step of determining the voltage balance.

12. The method recited in claim 11, wherein the drive cycle is vehicle specific, the method further comprising the step identifying the drive cycle based on vehicle identification information associated with the vehicle.

13. A device for determining a state of health of a vehicle battery on a hybrid vehicle, the device comprising:
a data connector operatively engageable with a diagnostic port on the vehicle; and
a processor in communication with the data connector, the processor being configured to implement the steps comprising:
receiving diagnostic data from a vehicle via the data connector, the diagnostic data including a diagnostic trouble code status, an internal resistance of the cells in the vehicle battery, and a temperature of the cells in the vehicle battery;
monitoring vehicle battery charging and vehicle battery discharging in accordance with a prescribed schedule;
requesting cell voltage when the vehicle battery charging meets a charging threshold and the vehicle battery discharging meets a discharging threshold;
receiving cell voltage and determining a voltage balance by comparing received voltages to a known average voltage range;
calculating a battery state of health based on a combined assessment of the diagnostic trouble code status, the internal resistance of the cells in the vehicle battery, the temperature of the cells in the vehicle battery, and the voltage balance; and
identifying at least one fix to improve the battery state of health.

14. The device recited in claim 13, further comprising a display screen in communication with the processor, the display screen being configured to display information related to the battery state of health.

15. The device recited in claim 14, wherein the display screen is configured to display the battery state of health in the format of a digital gauge.

16. The device recited in claim 14, wherein the processor is further configured to implement displaying driving instructions on the display screen for a drive cycle associated with the determination of the voltage balance.

17. The device recited in claim 16, wherein the processor is further configured to implement identification of driving instructions associated with a specified vehicle deceleration associated with the charging threshold and a specified vehicle acceleration associated with the discharging threshold.

18. The device recited in claim 16, wherein the drive cycle is vehicle specific, the processor further being configured to identify the drive cycle based on vehicle identification information associated with the vehicle.

19. The device recited in claim 13, wherein the diagnostic data additionally includes a number of cells in a vehicle battery on the vehicle.

20. The device recited in claim 13, wherein the charging threshold is associated with a specified vehicle deceleration.
